(19) United States
(12) Patent Application Publication
(10) Pub. No.: US 2018/0127081 A1
(43) Pub. Date: May 10, 2018

(54) PANEL STRUCTURE FOR AN AIRCRAFT AND MANUFACTURING METHOD THEREOF

(71) Applicants: Airbus Operations, S.L., Madrid (ES); Airbus Operations (S.A.S.), Toulouse (FR)

(72) Inventors: Javier TORAL VÁZQUEZ, Getafe (ES); Esteban MARTINO GONZALEZ, Aranjuez (ES); Diego FOLCH CORTES, Getafe (ES); Pablo GOYA ABAURREA, Madrid (ES); Vasillis VOTSIOS, Getafe (ES); Michel FOUINNETAU, Toulouse Cedex 09 (FR); Sylvain ROUMEGAS, Toulouse Cedex 09 (FR)

(21) Appl. No.: 15/803,559

(22) Filed: Nov. 3, 2017

(30) Foreign Application Priority Data
Nov. 4, 2016 (EP) 16382507.8

(51) Int. Cl. B64C 1/12; B32B 5/02; B32B 5/18; B64C 5/02; B64F 5/10

(52) U.S. Cl. CPC B64C 1/12; B32B 5/028; B32B 5/18; B64C 5/02; B64C 2001/0072; B32B 2605/18; B32B 2305/38; B32B 2305/30; B64F 5/10

(57) ABSTRACT

A panel structure for an aircraft with at least one composite layer, and at least one net-shaped layer attached to the composite layer, wherein the net-shaped layer has a material suitable to improve the impact resistance of the panel structure. The net-shaped layer can be used to attach two composite layers. Alternatively, the net-shaped layer can be attached to a surface of one composite layer. In this last case, the net-shaped layer may be joined to a laminate sheet material and filled with a foam material. An impact reinforced panel structure is disclosed capable of withstanding any impact, such as a blade release, or a bird strike, without substantially modifying the manufacturing process.

### CROSS-REFERENCE TO RELATED APPLICATION

This application claims the benefit of and priority to European patent application No. 16382507.8, filed on Nov. 4, 2016, the entire disclosure of which is incorporated by reference herein.

### TECHNICAL FIELD

The present disclosure refers in general to panel structures for the manufacture of an aircraft, in particular, for its fuselage and empennage section.

More in particular, it is an object of the present disclosure to provide a reinforced panel structure for an aircraft, which is capable of withstanding high energy impacts, such as a bird strike, a blade release, or an engine debris impact, with a minimized damage.

The disclosure herein also refers to a method for manufacturing such a panel structure.

### BACKGROUND

The use of composite materials formed by an organic matrix and unidirectionally orientated fibers, such as Carbon Fiber Reinforced Plastic (CFRP), in the manufacture of structural components of an aircraft, for example fuselage skin panels, torsion boxes, stringers, ribs, spars etc., is well known in the aeronautical industry.

Typically, skin panels are stiffened by several stringers longitudinally arranged, in order to provide strength and guarantee a proper buckling behavior of the skin panels. The stringers are conventionally co-cured, co-bonded, secondarily bonded or bolted to the skin panel.

These reinforced panels must be designed to meet both aerodynamics and structural requirements, such as a bird collision or blade release.

As known, bird-plane collisions during flight, take-off and landing happens every day, jeopardizing people and aircraft integrity.

Also, in propeller aircrafts, blades may break, in part or completely, or be entirely released from a propeller hub. Usually, these releases lead to serious damages in the aircraft structure and/or its systems due to the impact, and to unbalanced situations for the engine due to the broken or released blade.

For that, airworthiness authorities have requested aircraft manufacturers to consider the impact scenario due to a bird or a blade collision, in order to guarantee that the aircraft is capable of maintaining flight long enough to reach a landing site.

Current solutions are mainly based on providing localized reinforcements at spots indicated by debris trajectory studies. No significant modifications of the structure of the aircraft are considered, as penetration in the structure is allowed.

However, this situation changes if propeller engines are installed far from the central fuselage section, as in the rear section of the fuselage, where skin panels may be thinner and the residual strength after a blade impact may be compromised.

It would therefore be desirable to provide technical ways that comply with airworthiness requirements to ensure a safe continuation of flight and landing of an aircraft that had suffered a collision.

### SUMMARY

The present disclosure overcomes the above-mentioned drawbacks by providing a panel structure for an aircraft, which minimizes the damage caused by an impact.

One aspect of the present disclosure refers to a panel structure for an aircraft that comprises at least one composite layer and at least one net-shaped layer attached to the at least one composite layer, wherein the net-shaped layer comprises a material suitable or configured to improve the impact resistance of the panel structure.

Thus, the disclosure herein provides a new panel structure designed, including a high-strength internal net/skeleton. Thus, instead of traditional monolithic panels (metallics or composites), the disclosure herein provides panels with improved impact resistance performance.

With this configuration, panels are designed to spread loads through a large area (the net-shaped layer) when a high energy impact is received. This way, the disclosure herein offers an impact reinforced panel.

Another aspect of the disclosure herein refers to an aircraft, comprising a fuselage, an empennage, a skin covering the fuselage and the empennage, and a panel structure as described, wherein at least part of the fuselage and/or empennage skin is formed by the panel structure.

Finally, another aspect of the disclosure herein refers to a method for manufacturing a panel structure for an aircraft, comprising providing at least one layer of composite material, providing at least one net-shaped layer comprising a material suitable or configured to improve the impact resistance of the at least one composite layer, and attaching the at least one net-shaped layer to the at least one composite layer to form an impact reinforced panel structure.

The method of the disclosure herein provides several alternatives for attaching the net-shaped layer to the composite layer.

The method of the disclosure herein provides a simple and cost-effective way of producing an impact reinforced skin panel.

### BRIEF DESCRIPTION OF THE DRAWINGS

For a better comprehension of the disclosure herein, the following example drawings are provided for illustrative and non-limiting purposes, wherein:

FIG. 1 shows a schematic perspective view of a panel structure, according to a first embodiment of the present disclosure;

FIG. 2a-2c shows different configurations for the net-shaped layer;

FIG. 3 shows an image in which the load transfer behavior of the net-shaped layer can be appreciated;

FIG. 4 shows a schematic perspective view of a panel structure, according to a second embodiment of the present disclosure;

FIG. 5 shows a schematic perspective view of a panel structure, according to a third embodiment of the present disclosure; and

FIG. 6 shows a schematic perspective view of the arrangement of the net-shaped layer between two composite layers to form the panel structure of FIG. 1.

### DETAILED DESCRIPTION

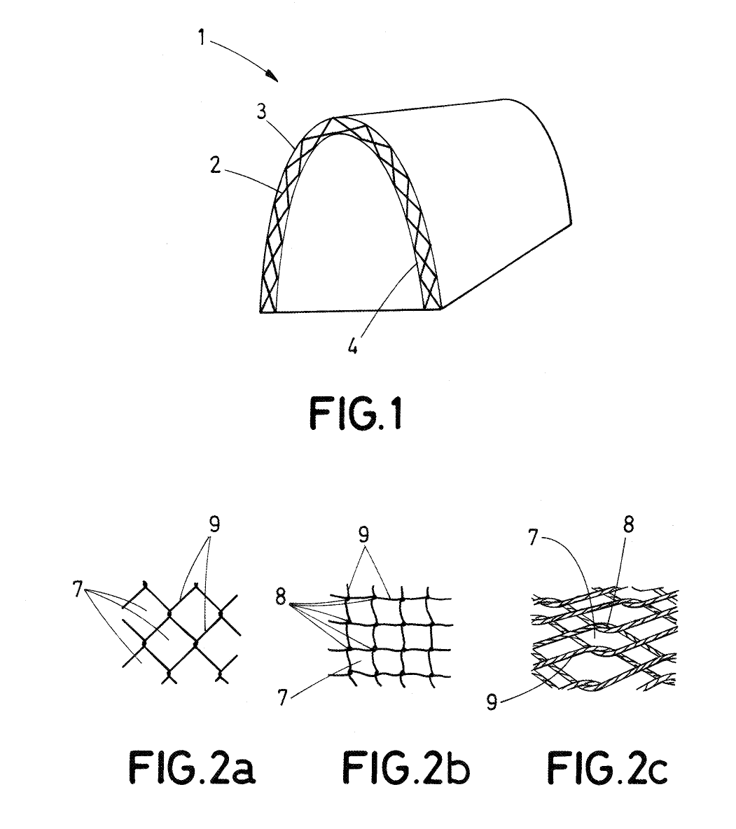

FIG. 1 shows a panel structure 1 for an aircraft according to a preferred embodiment. According to the disclosure herein, the panel structure 1 comprises at least one composite layer 3, 4 and at least one net-shaped layer 2 attached to the at least one composite layer 3, 4, and wherein the net-shaped layer 2 comprises a material suitable or configured to improve the impact resistance of the panel structure 1.

The panel structure 1 of FIG. 1 comprises an outer composite layer 3, an inner composite layer 4, and a net-shaped layer 2 arranged between the outer and inner layers 3, 4.

The net-shaped layer 2 of FIG. 1 is attached to two layers of composite material 3, 4, and it is thus integrated in the panel 1. This integration may be done by ATP (Automated Fiber/Tow Placement) in case of having a laminate skin panel (i.e. CFRP laminate).

Preferably, the net-shaped layer 2 comprises at least one of the following materials: steel, titanium, aluminium, carbon fiber, aramid fibers (Kevlar®), ultra high molecular polyethylene (Dyneema®), PBO (Zylon®).

With these materials, the net-shaped layer 2 provides an impact protection reinforcement that improves the damage tolerance capacity of a conventional panel skin of an aircraft. Thus, the panel of the disclosure herein increases the impact protection performance, and minimizes the damage area due to impacts.

The net-shaped layer 2 may have different configurations. Preferably, the net-shaped layer 2 has a polygonal configuration, such as a rhomboid configuration as shown in FIG. 2a, or square configuration, as shown in FIG. 2b.

In a preferred embodiment, the net-shaped layer 2 is set in knotted form, comprising a plurality of meshes 7 defined by corner knots 8 formed by at least two wires 9.

Also, as shown in FIG. 2c, the net-shaped layer 2 may have a double-chain link configuration. This embodiment provides a higher impact resistance to the panel structure 1.

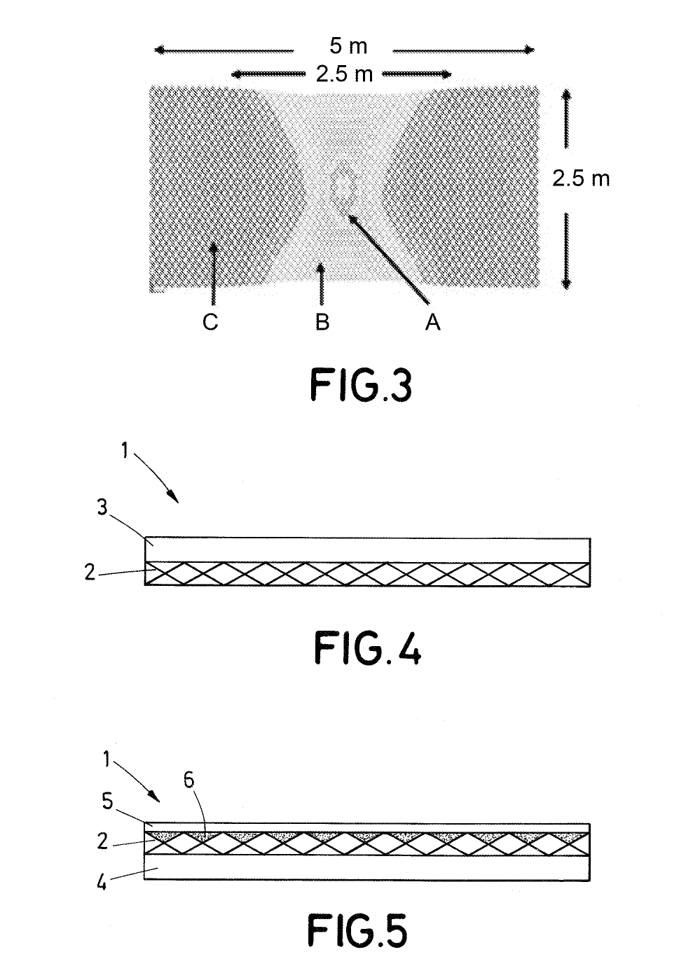

FIG. 3 shows the levels of stress of a net-shaped layer 2 of 5 meters of width and 2.5 meters of height after a high energy impact. As shown, the loads are transferred along the net-shaped layer 2 generating areas of medium (B) and low (C) levels of stress from a high level of stress (A). This way, the net-shaped layer 2 provides a panel structure 1 optimized for transferring loads caused by a high energy impact.

Thus, the net-shaped layer 2 acts as a barrier in case of a high energy impact, spreading the loads of the impact over the entire layer, and minimizing the damage contention.

As shown in FIGS. 4 and 5, and according to another preferred embodiments, the panel structure 1 comprises a composite layer 3, 4 and a net-shaped layer 2 attached to the composite layer 3, 4.

In the embodiment of FIG. 4, the net-shaped layer 2 is attached to an inner surface of an outer composite layer 3. Thus, the net-shaped layer 2 is added internally, for instance, being attached to the frames of the aircraft. The net-shaped layer 2 can be added to the aircraft baseline structure by rivets or bolts.

In the embodiment of FIG. 5, the net-shaped layer 2 is attached to an outer surface of an inner composite layer 4. Thus, the net-shaped layer 2 is externally added, also, by rivets or bolts.

As shown in FIG. 5, the panel structure 1 further comprises a laminate sheet material 5 joined to the net-shaped layer 2. Also, and according to a preferred embodiment, the panel structure 1 further comprises a foam material 6 to fill in the net-shaped layer 2.

The laminate sheet material 5 offers a smooth surface in order to fit the aerodynamic requirements of the panel structure 1. Also, the net-shaped layer 2 may be filled with a foam 6 or other light material to achieve an external smooth surface.

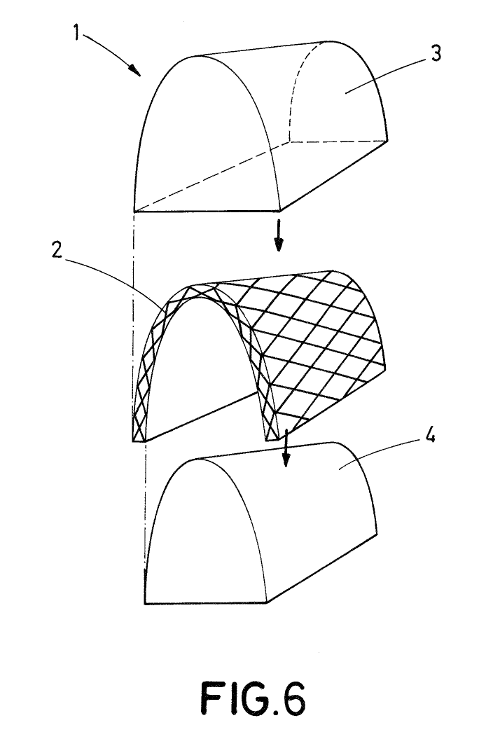

Finally, FIG. 6 shows a preferred embodiment for the manufacturing method of the disclosure herein.

According to the disclosure herein, the method for manufacturing a panel structure 1 for an aircraft comprises the steps of providing at least one layer of composite material 3, 4, providing at least one net-shaped layer 2, the net-shaped layer 2 comprising a material suitable or configured to improve the impact resistance of the at least one composite layer 3, 4, and attaching the net-shaped layer 2 to the at least one composite layer 3, 4 to form an impact reinforced panel structure 1.

Preferably, and as shown in FIG. 6, the net-shaped layer 2 is attached to two layers of composite material 3, 4. Thus, the method comprises providing an inner 4 and an outer layer of composite material 3, providing a net-shaped layer 2, the net-shaped layer 2 comprising a material suitable or configured to improve the impact resistance of the composite layers 3, 4, and attaching the net-shaped layer 2 to the two composite layers 3, 4 to form an impact reinforced panel structure 1.

While at least one exemplary embodiment of the present inventioin(s) has been shown and described, it should be understood that modifications, substitutions and alternatives may be apparent to one of ordinary skill in the art and can be made without departing from the scope of the disclosure described herein. This application is intended to cover any adaptations or variations of the specific embodiments discussed herein. In addition, in this disclosure, the terms “comprise” or “comprising” do not exclude other elements or steps, and the terms “a”, “an” or “one” do not exclude a plural number. Furthermore, characteristics or steps which have been described with reference to one of the above exemplary embodiments may also be used in combination with other characteristics or steps of other exemplary embodiments described above.

1. A panel structure for an aircraft comprising at least one composite layer and at least one net-shaped layer attached to the at least one composite layer, wherein the net-shaped layer comprises a material suitable to improve impact resistance of the panel structure.

2. The panel structure for an aircraft according to claim 1, wherein the net-shaped layer comprises at least one of the following materials: steel, titanium, aluminium, carbon fiber, aramid fibers (Kevlar®), ultra high molecular polyethylene (Dyneema®), PBO (Zylon®).

3. The panel structure for an aircraft according to claim 1, wherein the net-shaped layer has a polygonal configuration.

4. The panel panel structure for an aircraft according to claim 3, wherein the net-shaped layer has a rhomboid or square configuration.

5. The panel structure for an aircraft according to claim 1, wherein the net-shaped layer is set in knotted form, comprising a plurality of meshes defined by corner knots formed by at least two wires.

6. The panel structure for an aircraft according to claim 1, wherein the net-shaped layer is attached to two layers of composite material.

7. The panel structure for an aircraft according to claim 1, further comprising a laminate sheet material joined to the net-shaped layer.

8. The panel structure for an aircraft according to claim 7, wherein the net-shaped layer is filled with a foam material.

9. An aircraft, comprising a fuselage, an empennage, a skin covering the fuselage and the empennage, and a panel structure according to claim 1, wherein at least part of the fuselage and/or empennage skin is formed by the panel structure.

10. A method for manufacturing a panel structure for an aircraft, comprising:
providing at least one layer of composite material;
providing at least one net-shaped layer, the net-shaped layer comprising a material suitable to improve impact resistance of the at least one composite layer; and
attaching the net-shaped layer to the at least one composite layer to form an impact reinforced panel structure.

11. The method according to claim 10, wherein the net-shaped layer is attached to two layers of composite material.

12. The method according to claim 10, further comprising a laminate sheet material joined to the net-shaped layer.

13. The method according to claim 12, wherein the net-shaped layer is filled with a foam material.
